(19) United States
(12) Patent Application Publication
(10) Pub. No.: US 2011/0231769 A1
(43) Pub. Date: Sep. 22, 2011

(54) Systems and Methods for Scheduling Online Access

(76) Inventor: Tom C. Tovar, San Francisco, CA (US)

(21) Appl. No.: 12/897,568

(22) Filed: Oct. 4, 2010

Related U.S. Application Data
(63) Continuation-in-part of application No. 12/727,001, filed on Mar. 18, 2010.
(60) Provisional application No. 61/370,556, filed on Aug. 4, 2010.

(51) Int. Cl. G06F 15/177; G06F 3/048

(52) U.S. Cl. 715/735

(57) ABSTRACT

A system for restricting online access, in one example embodiment, includes a user interface module to establish a user interface between a user and a Domain Name Server network or an Internet Service Provider. The system further includes a communication module to receive, from the user, access parameters associated with an online access restriction policy for a network. The access parameters may include one or more periods of time associated with the online access restriction policy. Based on the parameters, the system may determine which content is to be inaccessible under online access restriction policy. The system may further include an activation module to activate and deactivate the online access restriction policy. The system may restrict the content requested by a network user based on the determination that the online access restriction policy is activated and the content is inaccessible under the online access restriction policy.

### CROSS-REFERENCE TO RELATED APPLICATIONS

This nonprovisional patent application is a continuation-in-part application that claims the priority benefit of U.S. patent application Ser. No. 12/727,001 filed on Mar. 18, 2010, titled “Internet Mediation,” and provisional U.S. Patent Application Ser. No. 61/370,556, filed on Aug. 4, 2010, titled “Internet Mediation Applications,” which are hereby incorporated by reference in their entirety.

### FIELD

This application relates generally to data processing and more specifically to systems and methods for scheduling online access.

### BACKGROUND

The values a family develops are traditionally the foundation for how children learn, mature and function in the world. Family values include ideas passed down from generation to generation. There are many activities that parents may undertake in order to define values. These activities are important and may require some quality time spent together with the children. Family meetings provide an opportunity for all family members to come together and share their thoughts, perspectives and their lives. A family meeting is an opportunity to prioritize the things your family values and establish traditions. The advent of the Internet has brought a major distraction to family meetings. Communications between family members are now severely affected by children's unwillingness to discontinue online browsing for the time of the family meetings.

Parents may use a number of scheduling programs, including electronic calendars, to set up recurring family meetings and accompanying notifications. However, a scheduling program may simply send an alert reminding of an approaching family meeting but might not provide the ability to reduce the distractions caused by online browsing during the meeting.

### SUMMARY OF THE INVENTION

A computer-implemented method for mediating online access may include providing a user interface between at least one user and an Internet service, and receiving from a user with administrative authority, via the user interface, a request to establish one or more online access restriction policies for a network, the request including access parameters. The access parameters may be used to establish periods of time during which access to Internet content not specifically excepted from the online access restriction policy is blocked.

The user interface provides a mechanism for the user with administrative authority to activate and deactivate the online access restriction policy.

The time periods defined by the access parameters may be defined relative to days of the week. The user with administrative authority may review and select online content that will then be excepted from the restriction access policy. A predetermined listing of excepted online content may be provided by the Internet service.

Designation of excepted Internet content may be established by either the user with administrative authority or by a group of otherwise unrelated end users with similar administrative authority. The latter method may be referred to as social development of the listing of excepted Internet content.

When Internet content is blocked, an explanation regarding the online access restriction policy may be provided to the requesting user. The user with administrative authority may have the ability to customize the explanation regarding the online access restriction policy.

A history of all attempts to access Internet content may be stored and made accessible for processing and analysis. The user with administrative authority may receive reports regarding the online access restriction policies, with the reports including, among any other desired data, a total amount of time each access restriction policy is in effect and any web content that a user attempted to access during the time a given access restriction policy was in effect.

### BRIEF DESCRIPTION OF THE DRAWINGS

Example embodiments are illustrated by way of example and not limitation in the figures of the accompanying drawings, in which like references indicate similar elements.

FIG. 1 is a block diagram of an access scheduling engine in accordance with an exemplary embodiment.

FIG. 2 illustrates a flow chart of a method for scheduling online access.

FIG. 3 is a screenshot of a description associated with an access scheduling application.

FIG. 4 is a screenshot of a configuration webpage for an end-user to provide configuration parameters associated with an online access restriction policy.

FIG. 5 is a screenshot of a terminal webpage that can appear in the event that content is inaccessible according to the online access restriction policy.

FIG. 6 is a schematic diagram of a DNS server arrangement that may support the systems and methods of the present invention.

FIG. 7 is a schematic of an exemplary system for scheduling online access for Internet users.

FIG. 8 illustrates an exemplary computing device that may be used to implement an embodiment of the present technology.

### DETAILED DESCRIPTION

Families may recognize the need to spend more time together as a family unit. Parents may value family time and want to change their current family dynamics. The parents may feel that their family unit is in jeopardy or that a cohesive family dynamic is being adversely impaired and, in either case, perceive the Internet to be one of the causes for the weakened relationship. The systems and methods disclosed herein for scheduling online access may allow family members to decrease the distractions caused by the Internet. It will be appreciated, however, that the systems and methods disclosed are not limited to this specific functionality and may be utilized to schedule online access in a variety of circumstances.

In various example embodiments, the systems and methods may be implemented as a part of an overall plan for improving family relations. The systems and methods may establish and embody an online access restriction policy without disrupting predetermined applications or sessions in process.

The systems and methods may facilitate blocking general Internet browsing when family time is taking place. However, certain predetermined content provided by, for example, movie and music streaming sites (e.g., Netflix and Pandora), may be allowed in order to promote family time. Additionally, the systems and methods may distinguish between Internet browsing and access to the Internet made by other devices or applications (e.g., VoIP phones). Such access may not be to the blocking provisions of the systems and methods.

The systems and methods may be utilized to establish a general rule for Internet use for a household and as a blocking mechanism to prevent household users from browsing the Internet during family time. A user may be allowed to create a weekly schedule designating times when Internet browsing is to be disabled. The user may be given selections for “off” times starting at specific times and ending at specific times. The systems and methods are device and platform independent.

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, and other embodiments can be formed by introducing structural and logical changes without departing from the scope of what is claimed. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

Generally speaking, an administrator may create and enforce restriction polices for one or more end users that utilize computing devices coupled to an Internet service delivered to a location such as a home, residence place of business or campus. The term “administrator” may include not only individuals, such as parents, but also any individual creating restriction policies regarding the Internet service delivered to end users. It will be understood that an administrator may also be an end user, although end users who are not also administrators may not create or apply restriction policies.

It will be further understood that because of the diversity of computing devices that may connect to the Internet service, the restriction policy may be applied to the Internet service rather than requiring the restriction policy to affect each computing device individually, such as a restriction application resident on each computing device. In various exemplary embodiments a restriction policy may also reside as a stand alone application on one or more of the computing devices.

Exemplary user devices for use with the disclosed systems may have a user interface. In various embodiments, such as those deployed on personal mobile devices, the user interface may be, or may execute, an application, such as a mobile application (hereinafter referred to as a (“app”). An app may be downloaded and installed on a user's mobile device. Users may define the access scheme via a user device, such as through the user interface. Some embodiments of the present invention do not require software to be downloaded or installed locally to the user device and, correspondently, do not require the user to execute a de-install application to cease use of the system.

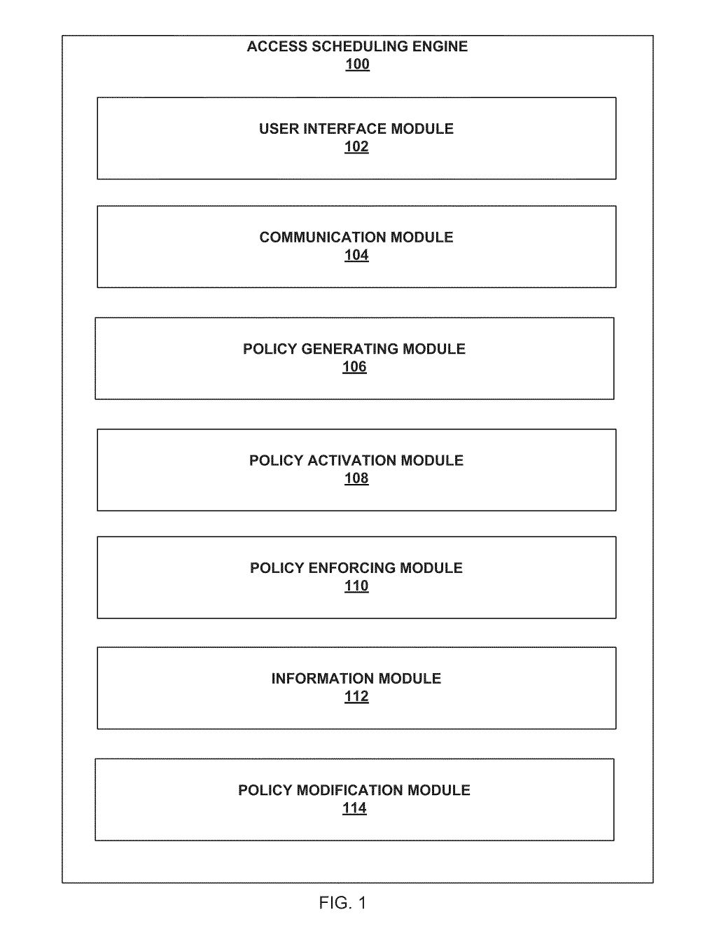

FIG. 1 is a block diagram of an access scheduling engine 100, in accordance with an example embodiment. Alternative embodiments of the access scheduling engine 100 may comprise more, less, or functionally equivalent modules. In some example embodiments, the access scheduling engine 100 comprises a user interface module 102, a communication module 104, a policy generating module 106, a policy activation module 108, a policy enforcing module 110, an information module 112, and a policy modification module 114. It will be appreciated by one of ordinary skill that examples of the foregoing modules may be virtual and instructions said to be executed by a module may, in fact, be retrieved and executed by a processor. The foregoing modules may also include memory cards, servers, and/or computer discs. Although various modules may be configured to perform some or all of the various steps described herein, fewer or more modules may be provided and still fall within the scope of various embodiments.

The user interface module 102 may be configurable to establish a user interface 710, which may be utilized by the user with administrative authority 670 at the user device 150. The user interface 710 generated by the user interface module 102 may be implemented in many embodiments. One specific implementation of the user interface 710 is as a web page. The user interface 710 may include a brief application description and one or more configuration prompts that permit the user with administrative authority 670 to configure an access scheduling method 200 with various parameters. Additionally, the user interface module 102 may enable the user with administrative authority 670 to activate and deactivate the access restriction policy, for example by using an On/Off button.

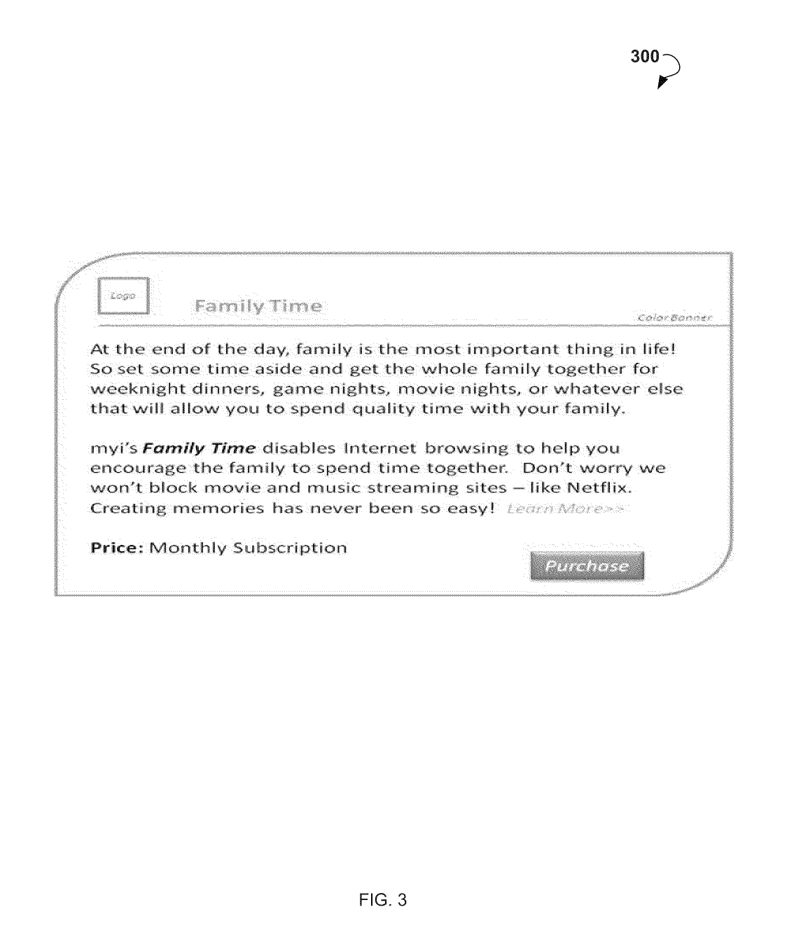

The description provided by the user interface module 102 within the application user interface 710 may be a brief summary of what the access scheduling method 200 does and how the user with administrative authority 670 can configure it. For example, the description may begin with one or two sentences describing the functionality of the access scheduling method 200. The description may outline steps in configuring settings of the access scheduling method 200. An example description is illustrated below with reference to FIG. 3.

The communication module 104 may be configurable to provide a communication channel between the access scheduling engine 100 and various components of the Internet service, including but not limited to, the access scheduling method 200. Additionally, the communication module 104 may enable direct exchange of information between various modules of the access scheduling engine 100 within the Internet service. For example, the communication module 104 may facilitate receiving access restriction policy configurations provided by the user with administrative authority 670 via the application user interface 710.

When the user with administrative authority 670 submits the access restriction policy configurations, the policy generating module 106 can generate an appropriate access restriction policy. For example, in response to the user selecting a time period during which the policy is to be implemented, the policy generating module 106 may generate a policy which will prevent online browsing during the specified time period.

In some example embodiments, saving access restriction policy configurations may not automatically activate the associated access restriction policy. Therefore, the policy activation module 108 may be utilized to activate the access restriction policy. The policy activation module 108 may also be utilized to deactivate the access restriction policy if the user with administrative authority 670 wishes to terminate the access restriction policy.

In order to define the access restriction policy, the user with administrative authority 670 may enter one or more days of the week as well as starting and ending times of the time periods in which the online browsing is inaccessible. Additionally, the user with administrative authority 670 may indicate whether or not the periods of times in which the online browsing is inaccessible are to be repeated.

When the network user 660 attempts to browse the Internet, the policy enforcing module 110 may determine whether the access restriction policy is active. If the access restriction policy is active, the requested content is not provided. Upon such determination, the policy enforcing module 110 may enforce the restriction policy by blocking the access. The information module 112 may be utilized to inform the network user 660 that the content is inaccessible for a period of time and the reasons behind the access restriction policy. The user with administrative authority 670 may wish to modify the access restriction policy to make the online browsing inaccessible in different time periods. The policy modification module 114 may allow modifying the access restriction policy by altering the accessibility of the online browsing.

In some example embodiments, the user with administrative authority 670 wishing to schedule online access for the network users 660 may do so by a voluntary agreement of the network users 660, and in some cases the agreement may emanate from the network users 660 themselves. In this way, the access scheduling method 200 may function as the digital assistant to both the user with administrative authority 670 and the network user 660 and function as the digital embodiment of an offline agreement.

Traditionally, dinner time has provided an opportunity in which families could come together and talk about what is going on in each other's lives. The ubiquity and immediate availability of the Internet may threaten this basic family dynamic. Systems and methods for scheduling online access may enable the user with administrative authority 670 to schedule a dinner time in which the entire family is unable to use their mobile devices or computers to browse online content. Instead, they gather round the dinner table.

In another example, a family night may be a designated evening in which the family spends quality time together. It may include various activities that bring the entire family together. For example, one of America's pastimes is a game night. Traditionally, this night consisted of families playing board or card games together. However, now a game night may include playing games on a game console (e.g., Nintendo Wii). The game console may utilize Internet access for networking with other players and updates. Therefore, the access scheduling method 200 may distinguish the game console and allow the Internet access even when the general online browsing is prevented by the access restriction policy. The actual time that Internet browsing is disabled may be very brief. The user with administrative authority 670 may be able to configure the “off” times in small increments (e.g., 15 minutes) to ensure broad applicability.

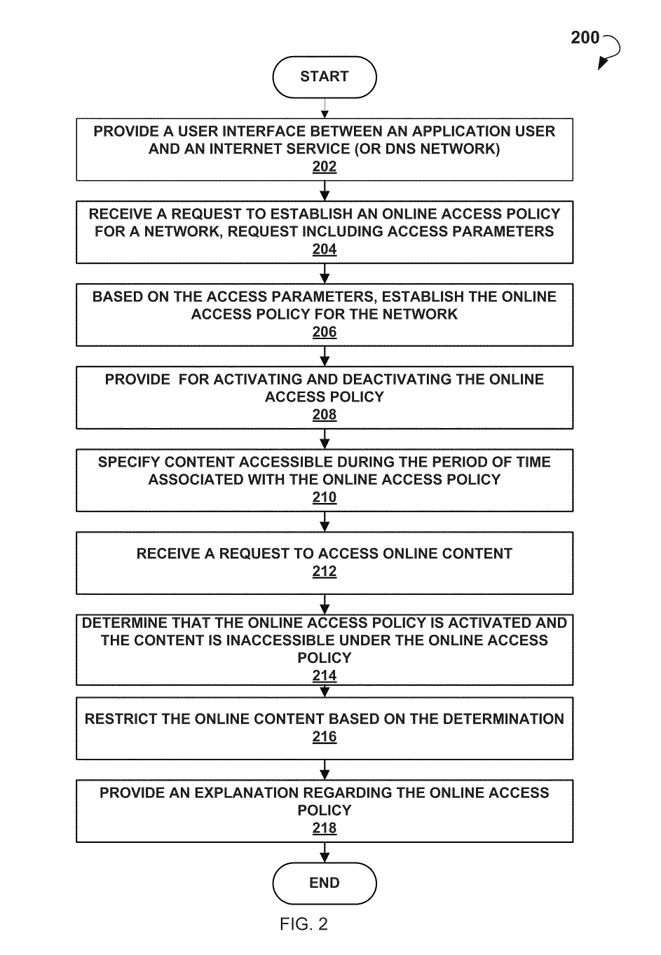

FIG. 2 illustrates a flow chart of a method 200 for restricting online access, in accordance with an example embodiment. The method 200 may be performed by processing logic that may comprise hardware (e.g., dedicated logic, programmable logic, microcode, etc.), software (such as run on a general-purpose computer system or a dedicated machine), or a combination of both. In one example embodiment, the processing logic resides at the access scheduling engine 100 illustrated in FIG. 1.

The method 200 may be performed by the various modules discussed above with reference to FIG. 1. Each of these modules may comprise processing logic. The method 200 may commence at operation 202 with the user interface module 102 establishing a user interface 710 between the user with administrative authority 670 and the Internet service. Using the user interface 710, the user with administrative authority 670 may provide input for the baseline online access restriction policy. As mentioned above, the user with administrative authority 670 may be able to adjust the online access restriction policy by changing time periods or by deactivating the online access restriction policy altogether.

Using the user interface 710, the user with administrative authority 670 may enter configuration requirements for the online access restriction policy. In some example embodiments, the configuration parameters may include a schedule (of times and days) when the user with administrative authority 670 wishes to limit the access to online browsing until the access scheduling method 200 is deactivated. The method 200 can proceed to operation 204, where the communication module 104 of the access scheduling engine 100 may receive user input related to the online access restriction policy for the network 260. The network 260 may be a home network, office network, or any other type of computer network.

At operation 204, the user with administrative authority 670 may provide periods of time associated with the online access restriction policy. For example, the user with administrative authority 670 may select Monday as the day of the week, with 7:00 PM as the start and 8:00 PM as the finish time for the restriction period. In another example, the user with administrative authority 670 may specify that the restriction is to be repeated every week by selecting the repeat checkbox. This means that online browsing will be unavailable every Monday from 7 PM to 8 PM.

At operation 206, the user with administrative authority 670 may establish the online access restriction policy by saving the settings. As mentioned above, saving the settings may not necessarily activate the access scheduling method 200, and additional actions may be needed. At operation 208, the user with administrative authority 670 may choose to terminate the online access restriction policy by disabling the functionality of the access restriction policy application. Upon providing the indication to this end, the policy activation module 108 may deactivate the online access restriction policy. Thus the Internet may be both turned off and restored on-demand. Because some internet browsing may be needed during the access restriction policy implementation, at operation 210, the user with administrative authority 670 may specify content which will be accessible during the period of time associated with the online access restriction policy. For example, the user with administrative authority 670 may provide a domain name of the website, a name of the application, or a category of the application.

At operation 212, the communication module 104 may receive, from the network user 660, a request to access specific content (e.g., www.facebook.com). Upon receiving the request, the policy enforcement module 110 may determine at decision block 214 whether or not an online access restriction policy is activated. If there is no active online access restriction policy at the moment, the policy enforcing module 110 may allow the network user 660 to access the content. If, on the other hand, there is an active online access restriction policy, the method 200 may determine whether the requested content is to be allowed despite the access restriction policy being in effect. If it is determined at decision block 214 that the content is to be allowed, the policy enforcement module 110 may allow the content to be accessed. Otherwise, the content may be restricted at operation 216 and the network user 660 redirected to a default webpage.

Thus, if the network user 660 attempts to access content that is restricted according to the online access restriction policy, he may be redirected to the default webpage instead of the requested content. At operation 218, the information module 112 may provide an explanation of why the network user 660 has been presented with the default webpage instead of the content he was trying to access. For example, the default webpage may explain that the attempt to access the content by the network user 660 has been denied and that the denial is the result of the online access restriction policy established by the user with administrative authority 670.

FIG. 3 is a screenshot of a description 300 associated with the access scheduling method 200, in accordance with an example embodiment. The description 300 may generally describe what the access scheduling method 200 does. As shown in FIG. 3, the description 300 may begin with one or two sentences describing the functionality of the access scheduling method 200. In some example embodiments, the description 300 may outline steps in configuring settings for the access scheduling method 200.

For example, the description may help reinforce or remind users about the importance of spending time together as a family. The first paragraph may remind users how important family is and continue to suggest the various ways they can spend time together. The second paragraph may briefly summarize the application functionality.

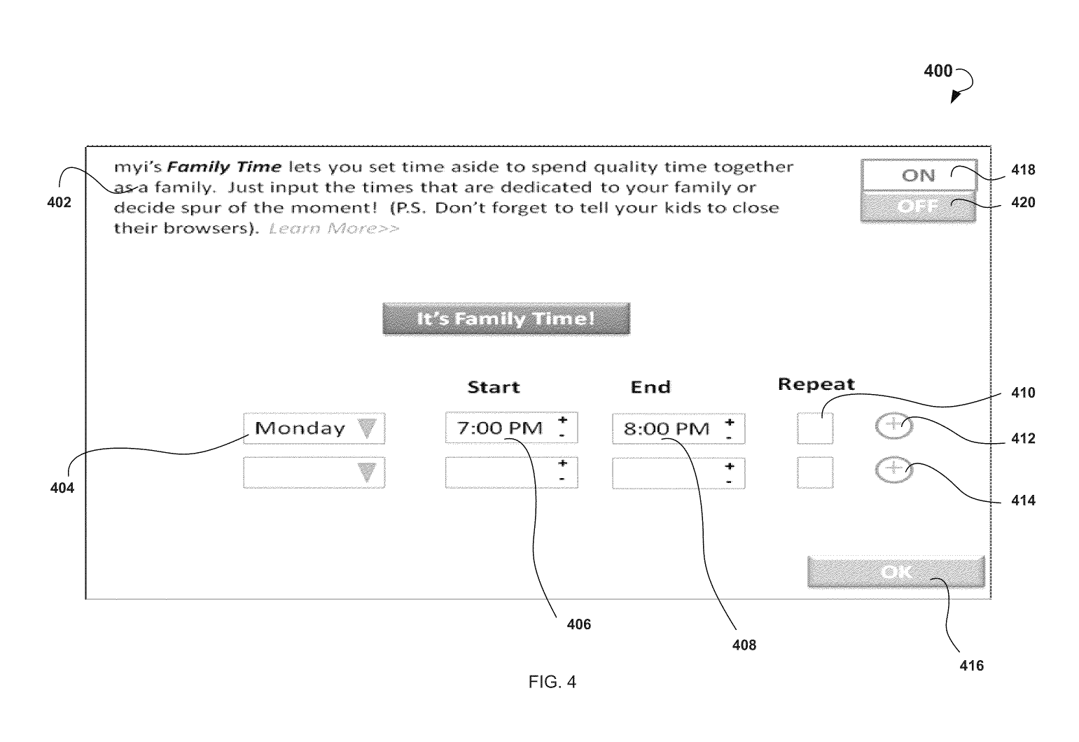

FIG. 4 is a screenshot of a configuration webpage 400. The configuration webpage 400 may be utilized by the user with administrative authority 670 to provide configuration parameters associated with the online access restriction policy, in accordance with an example embodiment. In some example embodiments, the configuration webpage 400 may comprise a description text 402, one or more days of the week drop down menus 404, one or more start times 406, one or more end times 408, one or more repeat check boxes 410, one or more domain addition buttons 412, one or more domain subtraction buttons 414, an online access restriction policy save button 416, an online access restriction policy activation button 418, and an online access restriction policy deactivation button 420.

The user with administrative authority 670 may create a schedule by specifying when the online access is to be turned off (“Start” field) and when the online access is to be turned back (“End” field). In the example embodiment, the user with administrative authority 670 may have different ways in which he may enter time. For example, the user with administrative authority 670 may click the box and enter the time or use the arrows to the right of the box to get to the time of his choice. The arrows may, for example, adjust the displayed time in half hour increments. However, the user with administrative authority 670 may enter any time he wishes. Time settings may, for example, be determined for each of the following day(s):

Everyday

Monday-Thursday

Weekends

Each Day Independently (i.e. Monday, Tuesday, Wednesday, etc.)

The user with administrative authority 670 may select to set up recurring events by selecting the “Repeat” checkbox 410. By clicking this box, it may be assumed that the user with administrative authority 670 would like to prevent online browsing on a weekly basis. The user with administrative authority 670 may continue adding line items by clicking the plus sign 412 on the right hand side until they have created the schedule that they desire. Once the user with administrative authority 670 has finished entering their settings, they may hit the “OK” button to have their settings saved and stored for future use.

Once the access scheduling method 200 is employed, new browsing sessions may be disabled. If, for some reason, any of the network users 660 need to access the Internet during the access restriction policy being active, the user with administrative authority 670 may restore Internet connection by modifying current settings.

In some example embodiments, if the user with administrative authority 670 saves the settings but neglects to enable the access scheduling method 200, he can be presented with an overlay asking whether he wishes to enable the online access restriction policy before closing the configuration webpage 400. If, after the access scheduling method 200 is activated, the user with administrative authority 670 wishes to terminate the online access restriction policy earlier, he may do so by clicking on the online access restriction policy deactivation button 420 to disable the access scheduling method 200. Doing so may not result in deleting the settings for the access scheduling method 200. In addition to the initial setup, the configuration webpage 400 may be used to modify the settings of the access scheduling method 200.

During times affected by the access restriction policy, the user with administrative authority 670 may allow access to selected Internet content such as steaming music or online games. The user with administrative authority 670 can designate allowed Internet content, and may socially produce (i.e. produce in an otherwise unrelated group) access restriction policies with other users with administrative authority, and share his and the group policies with other users with administrative authority. The group that produces an access restriction policy may or may not include the user with administrative authority 670 of the subject network.

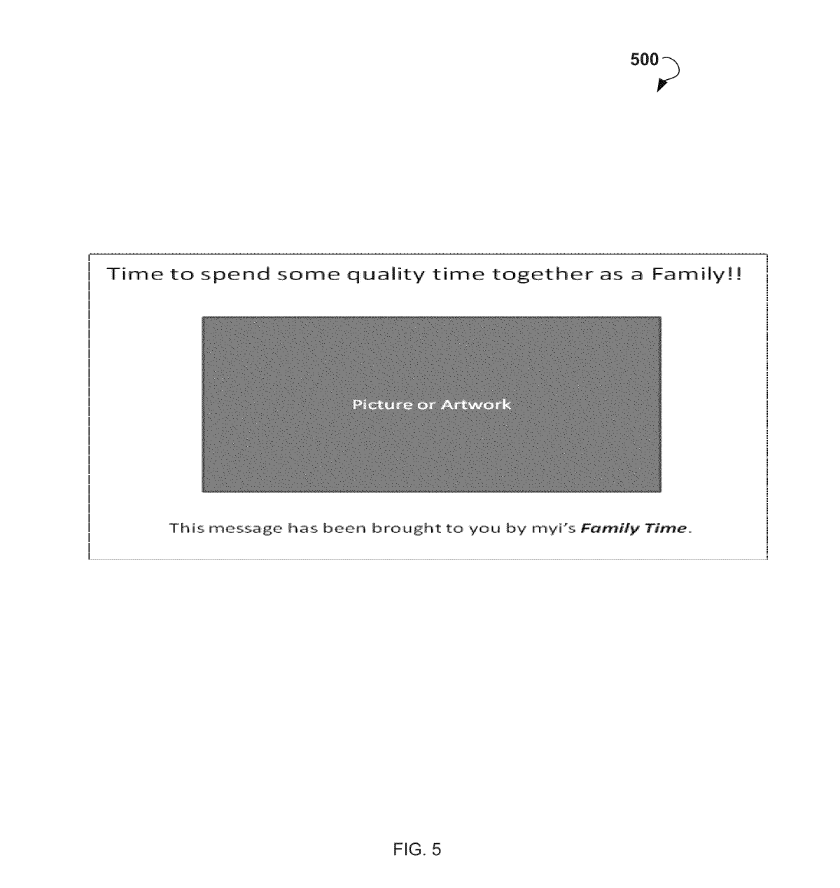

FIG. 5 is a screenshot of a default webpage 500 that may appear in the event that content is restricted according to the online access restriction policy. If one of the network users 660 attempts to access content that is blocked by online access restriction policy, they may be redirected to the default webpage 500 instead of their requested content. The user with administrative authority 670 may also customize the content of the default webpage.

The systems and methods described above may typically be resident in an Internet service or a DNS network. The systems and methods described may also be implemented in plug-in utilities, gateway devices, cable modems, proxy servers, set top boxes, and network interface devices.

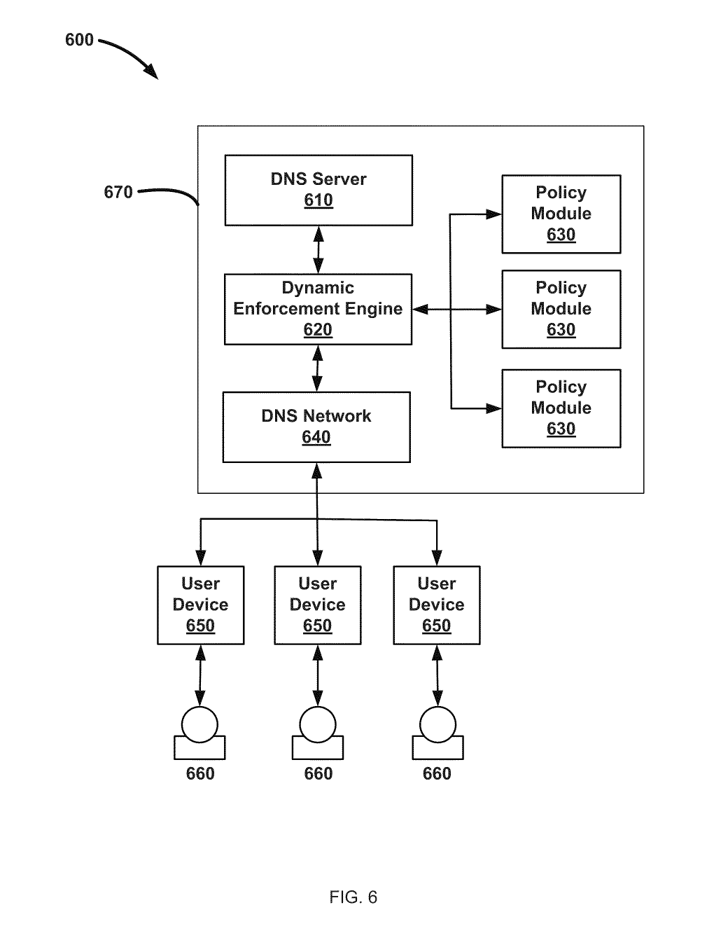

FIG. 6 illustrates an exemplary Internet service system 600, with a DNS server 610, that may be utilized to support the above described systems and methods. The DNS server 610 operates in conjunction with a dynamic enforcement engine 620. The dynamic enforcement engine 620 may operate in conjunction with one or more policy modules 630 to establish any applicable polices at the DNS 610 level. The content rules are applied to received user queries, and determine the content that is delivered by the DNS network 640 through various user devices 650 to the end users 660.

The dynamic enforcement engine 620 may generate its policy engine on instructions received from one or more policy modules 630. Each policy module 630 may be constructed to provide various types and levels of services to the DNS network 640. In various embodiments, a policy module 630 may be configured to handle queries directed to subjects including, but not limited to, malicious domain redirection, user access redirection, non-existent domain redirection, and data collection or analysis.

It will be recognized by those skilled in the art that the elements of DNS service 670 may be hosted either locally or remotely. In addition to residing in the DNS service 670, one or more of the DNS network 640, the dynamic enforcement engine 620, and the policy modules 630, and any combination thereof, may be resident on one or more user devices 650.

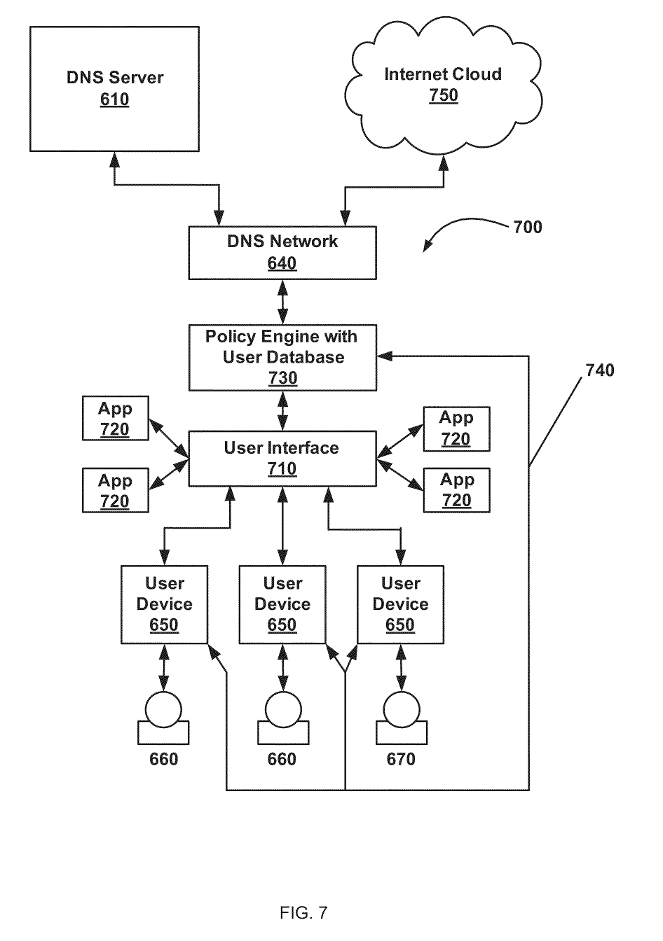

FIG. 7 shows a schematic layout of an exemplary system 700 for implementing direct and variable end user control. FIG. 7 illustrates that the system 700 may operate installed on a DNS server 610, or with a cloud 750 based installation.

The system 700 utilizes a user interface 710. The user interface 710 may be implemented in many embodiments. One specific implementation of the user interface 710 is as a web page.

The user interface 710 may be accessed by one or more user devices 650 operated by the users 660. The user interface 710 may be accessed though a gateway user device 650 available to the users 660. Suitable user devices 650 include but are not limited to desktops, PCs, laptops, tablets, notebooks, gaming devices, music players, Smartphones, automobile computer systems, and Internet enabled TVs. The system 700 may also be accessed and controlled remotely through user devices 650, such as a Smartphone or other specialized Internet access device. A Smartphone may be defined as a phone with computing capability. A Smartphone may provide the user with Internet access.

The user interface 710 provides a mechanism for one or more authorized users 660 to establish content policy for the Internet service. The user interface 710 operates between the user devices 650 present in the system 700 and the DNS network 640. Instructions resident on the user interface 710 therefore operate on the Internet service, by controlling at least a portion of DNS resolutions via a dynamic policy engine 730, before the service reaches the displays of the user devices 650.

The user interface 710 provides the users 660 with access to one or more policy applications 720. The user interface 710 may provide access to a selection list to at least one authorized user 660. The authorized user 660 uses the selection list or some other menu mechanism to select those policy applications 720 that the user 660 chooses to apply to the system 700. The authorized user 660 may select any number of the available policy applications for use on the system 700 at any given time. In implementations utilizing Smartphones as the user device 650, the policy applications 720 are downloaded to the device 650. The device 650 then serves as the user interface 710 to communicate directly with the dynamic policy engine 730.

The policy applications 720 may prohibit access to specific sites. The policy applications 720 may also limit the time of day when users or selected users 660 may access certain sites. The policy applications 720 may also manage and analyze duration of access to various sites. It is important to note that the policy applications 720 do not simply provide blocking mechanisms by masking or enabling network controls, but rather mediate an Internet service received by the end user. As used herein, mediating the service may include any of blocking, constraining, enabling, redirecting, promoting, demoting, substituting, obscuring, limiting, interrupting, and restricting all or a portion of the Internet service. The policy applications 720 may provide notifications or alerts to one or more users 660 when sites are accessed. The policy applications 720 may also provide notification of frequency and duration of access of designated sites. The policy applications 720 may also be used to observe, substitute, enable, redirect users, to reward behavior desired from the users by a system administrator, etc. The policy applications 720 may redirect users from a non-favored site to another site. The policy applications 720 may also collect and transmit data characteristic of Internet use.

Access policies supplied by the policy applications 720 may apply to all users 660 of the system 700, or the access policies may be specific to individual users or groups of users 660. The policy applications 720 may be discrete, single purpose applications.

The policy applications 720 provide the users 660 with a mechanism to take various actions relative to their Internet service feed. The policy applications 720 also allow the users 660 to establish a dynamic policy engine 730 that includes a user database. The policy engine 730 is used to enforce rules associated with each policy application associated with individual end users, not simply block various inappropriate sites from the Internet feed. Rather, the dynamic policy engine 730, controlled by the user interface 710 through user device(s) 650, is used to manage all aspects of the Internet experience for the users 660. In sum, the policy applications 720 may be used to configure the dynamic policy engine 730 to provide the users 660 with a mechanism to personalize the Internet experience. The policy applications 720 may be configured in combinations, and may each be separately configured.

The database in the policy engine 730 may be used to record and to notify users 660 of various data relative to Internet access. The data collected from and provided to the users 660 may include records of access of specific sites, time spent on specific sites, time of day of access, data specific to individual users, etc.

It should also be noted that following an initial setup through the user interface 710 of the policy engine 730, a direct access 740 enforcement loop may be established between the policy engine 730 and the user devices 650. Subsequent accessing of the DNS network 640 utilizing the direct access 740 decreases response time in the system 700, thereby further enhancing the Internet experience of the users 660. Configurations of policy applications 720 that are selected by one or more users 660 designated as system administrators may remain in the user database of the policy engine 730 until such time as it may be modified by the system administrators. The system administrators may define multiple policy configurations, with a combination of policy applications 720, applicable to one or more end users 660 of the system 700. Each policy application 720 may be separately configurable as well. Policy configurations may vary based upon designated times, conditional triggers, or specific requests from the users 660 with administrative authority.

As indicated above, two discrete data flow paths may be established for the system 700. A first data path establishes a set of enforcement policies for the system 700. The first data path flows from at least one user device 650 through the user interface 710, to the policy enforcement engine 730. A second data path 740 may be utilized following the establishment of a set of policies for the system 700. The second data path 740 flows directly between the user device(s) 650 and the policy engine 730. Multiple sets of enforcement policies may be established and saved within the system 700 and implemented selectively by the users 660.

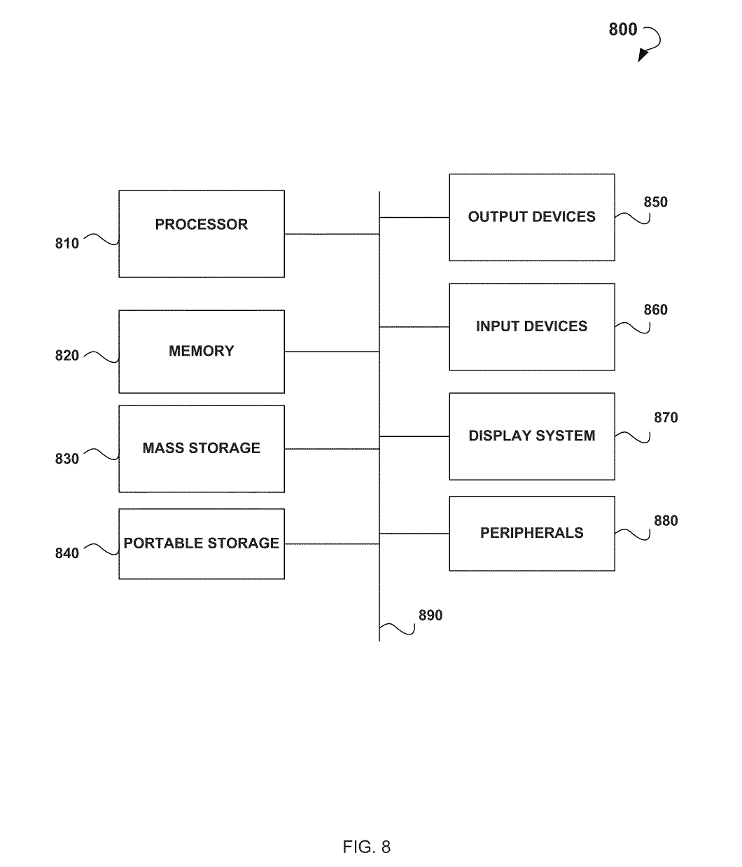

FIG. 8 illustrates an exemplary computing system 800 that may be used to implement an embodiment of the present invention. System 800 of FIG. 8 may be implemented in the context of user devices 650, DNS server 610, Internet cloud 750 and the like. The computing system 800 of FIG. 8 includes one or more processors 810 and memory 820. Main memory 820 stores, in part, instructions and data for execution by processor 810. Main memory 820 can store the executable code when the system 800 is in operation. The system 800 of FIG. 8 may further include a mass storage device 830, portable storage medium drive(s) 840, output devices 850, user input devices 860, a graphics display 840, and other peripheral devices 880.

The components shown in FIG. 8 are depicted as being connected via a single bus 890. The components may be connected through one or more data transport means. Processor unit 810 and main memory 820 may be connected via a local microprocessor bus, and the mass storage device 830, peripheral device(s) 880, portable storage device 840, and display system 870 may be connected via one or more input/output (I/O) buses.

Mass storage device 830, which may be implemented with a magnetic disk drive or an optical disk drive, is a non-volatile storage device for storing data and instructions for use by processor unit 810. Mass storage device 830 can store the system software for implementing embodiments of the present invention for purposes of loading that software into main memory 810.

Portable storage device 840 operates in conjunction with a portable non-volatile storage medium, such as a floppy disk, compact disk or Digital video disc, to input and output data and code to and from the computer system 800 of FIG. 8. The system software for implementing embodiments of the present invention may be stored on such a portable medium and input to the computer system 800 via the portable storage device 840.

Input devices 860 provide a portion of a user interface. Input devices 860 may include an alpha-numeric keypad, such as a keyboard, for inputting alpha-numeric and other information, or a pointing device, such as a mouse, a trackball, stylus, or cursor direction keys. Additionally, the system 800 as shown in FIG. 8 includes output devices 850. Suitable output devices include speakers, printers, network interfaces, and monitors.

Display system 870 may include a liquid crystal display (LCD) or other suitable display device. Display system 870 receives textual and graphical information, and processes the information for output to the display device.

Peripherals 880 may include any type of computer support device to add additional functionality to the computer system. Peripheral device(s) 880 may include a modem or a router.

The components contained in the computer system 800 of FIG. 8 are those typically found in computer systems that may be suitable for use with embodiments of the present invention and are intended to represent a broad category of such computer components that are well known in the art. Thus, the computer system 800 of FIG. 8 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including UNIX, Linux, Windows, Macintosh OS, Palm OS, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the invention. Those skilled in the art are familiar with instructions, processor(s), and storage media.

It is noteworthy that any hardware platform suitable for performing the processing described herein is suitable for use with the invention. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or cartridge, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents. While the present invention has been described in connection with a series of embodiments, these descriptions are not intended to limit the scope of the invention to the particular forms set forth herein. It will be further understood that the methods of the invention are not necessarily limited to the discrete steps or the order of the steps described. To the contrary, the present descriptions are intended to cover such alternatives, modifications, and equivalents as may be included within the spirit and scope of the invention as defined by the appended claims and otherwise appreciated by one of ordinary skill in the art. For example, this description describes the technology in the context of an Internet service in conjunction with a DNS server. It will be appreciated by those skilled in the art that functionalities and method steps that are performed by a DNS server may be performed by an Internet service.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the invention as described herein.

One skilled in the art will further appreciate that the term “Internet content” encompasses any content that may be access by an Internet enabled user device including but not limited to one or more of web sites, domains, web pages, web addresses, hyperlinks, URLs, any text, pictures, and/or media (such as video, audio, and any combination of audio and video) provided or displayed on a web page, and any combination thereof. A restriction policy may include any of blocking, constraining, enabling, redirecting, promoting, substituting, obscuring, limiting, interrupting.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or subcombinations. Each of these processes or steps may be implemented in a variety of different ways. Also, while processes or steps are at times shown as being performed in series, these processes or steps may instead be performed in parallel, or may be performed at different times.

From the foregoing, it will be appreciated that specific embodiments of the system have been described herein for purposes of illustration, but that various modifications may be made without deviating from the spirit and scope of the system. Accordingly, the disclosure is not limited except as by the appended claims.

What is claimed is:

1. A computer-implemented method for mediating online access, the method comprising:
providing a user interface between at least one user and an Internet service;
receiving from a user with administrative authority, via the user interface, a request to establish one or more online restriction policies for a network, the request including access parameters; and
based on the access parameters, establishing one or more time periods during which access to Internet content not specifically excepted is blocked.

2. The computer-implemented method of claim 1, wherein the user interface provides a mechanism for activating and deactivating the online restriction policy.

3. The computer-implemented method of claim 1, wherein the access parameters are defined relative to days of the week.

4. The computer-implemented method of claim 1, wherein the Internet service includes a predefined a set of excepted Internet content that all of the end users can access while the restriction policy is in effect.

5. The computer-implemented method of claim 1, wherein the at least one element of the restriction policy resides on a DNS server.

6. The computer-implemented method of claim 1, wherein a DNS server enforces at least one element of the restriction policy.

7. The computer-implemented method of claim 1, wherein at least one element of the Internet service resides on a user device.

8. The computer-implemented method of claim 1, further comprising the user with administrative authority reviewing and selecting online content to be excepted from the restriction policy.

9. The computer-implemented method of claim 1, wherein excepted Internet content is selected by either the user with administrative authority or by a group of otherwise unrelated end users with similar administrative authority.

10. The computer-implemented method of claim 1, further comprising receiving, from a network user, a request to access online content, determining that the online access restriction policy is activated and the content is inaccessible under the online access restriction policy, and based on the determination, blocking the online content.

11. The computer-implemented method of claim 10, further comprising providing, to the network user, an explanation regarding the online access restriction policy.

12. The computer-implemented method of claim 11, wherein the user with administrative authority has the ability to customize the explanation regarding the online access restriction policy.

13. The computer-implemented method of claim 1, wherein the network is a home network.

14. The computer-implemented method of claim 1, the user with administrative authority specifics different restriction policies for different locations.

15. The computer-implemented method of claim 1, further comprising receiving from the user with administrative authority, via the user interface, a further request to modify the online access restriction policy, the request being associated with further access parameters, and based on the further access parameters, modifying the online access restriction policy.

16. The computer-implemented method of claim 1, wherein a history of all attempts to access Internet content is stored and accessible for processing and analysis.

17. The computer-implemented method of claim 1, wherein the user with administrative authority receives reports regarding the online access restriction policies, the reports including a total amount of time each access restriction policy is in effect and any web content that a user attempted to access during the time a given access restriction policy was in effect.

18. A computer-implemented system for restricting online access, the system comprising:
a user interface module to provide a user interface between at least one user and an Internet service;
a communication module to receive, from a user with administrative authority via the user interface, a request to set at least one online access restriction policy for a network, the request including access parameters; and
a policy generating module to establish, based on the access parameters, one or more time periods during which access to Internet content not specifically excepted is blocked.

19. The computer-implemented system of claim 18, wherein the Internet service includes a predefined a set of excepted Internet content that all end users access while the restriction policy is in effect.

20. The computer-implemented system of claim 18, wherein the at least one element of the restriction policy resides on a DNS server.

21. The computer-implemented system of claim 18, wherein a DNS server enforces at least one element of the restriction policy.

22. The computer-implemented system of claim 18, further comprising a policy activation module to activate and deactivate the online access restriction policy.

23. The computer-implemented system of claim 18, further comprising a policy enforcing module to receive from a network user a request to access content, to determine that the online access restriction policy is activated and the content is inaccessible under the online access restriction policy, and based on the determination, to block the content.

24. The computer-implemented system of claim 20, further comprising an information module to provide, to the network user, information regarding the online access restriction policy.

25. The computer-implemented system of claim 18, further comprising a policy modification module to receive from the user, via the user interface, a further request to modify the online access restriction policy, the request including further access parameters, and to modify the online access restriction policy based on the further restriction parameter.

26. The computer-implemented system of claim 18, wherein at least one element of the Internet service resides on a user device.

27. A non-transitory machine-readable medium comprising instructions, which when implemented by one or more processors, perform the following operations:
provide a user interface between at least one user and an Internet service;
receive from a user with administrative authority, via the user interface, a request to establish one or more online access restriction policies for a network, the request including access parameters; and
establish the online access restriction policy for the network based on the access parameters, the access restriction policy during one or more time periods blocking access to Internet content which is not specifically excepted.

28. A computer-implemented method for mediating online access, the method comprising:
providing a user interface between at least one user and a DNS server;
receiving from a user with administrative authority, via the user interface, a request to establish one or more online access restriction policies for a network, the request including access parameters established by a DNS server; and
based on the access parameters, establishing one or more time periods during which access to Internet content not specifically excepted is blocked.

29. The computer-implemented method of claim 28, wherein the Internet service includes a predefined a set of excepted Internet content that all end users access while the restriction policy is in effect.

30. The computer-implemented method of claim 28, wherein the user interface provides a mechanism for activating and deactivating the online restriction policy.

31. The computer-implemented method of claim 28, wherein the access parameters are defined relative to days of the week.

32. The computer-implemented method of claim 28, further comprising the user with administrative authority reviewing and selecting online content to be excepted from the restriction access policy.

33. The computer-implemented method of claim 32, wherein the Internet service includes a predefined a set of excepted Internet content that all of the end users can access while the restriction policy is in effect.

34. The computer-implemented method of claim 28, wherein excepted Internet content is established by either the user with administrative authority or by a group of otherwise unrelated end users with similar administrative authority.

35. The computer-implemented method of claim 28, further comprising receiving, from a network user, a request to access online content, determining that the online access restriction policy is activated by a DNS server and the content is inaccessible under the online access restriction policy, and based on the determination, blocking the online content.

36. The computer-implemented method of claim 35, further comprising providing, to the network user, an explanation regarding the online access restriction policy.

37. The computer-implemented method of claim 32, wherein the user with administrative authority has the ability to customize the explanation regarding the online access restriction policy.

38. The computer-implemented method of claim 28, wherein the network is a home network.

39. The computer-implemented method of claim 28, further comprising receiving from the user with administrative authority, via the user interface, a further request to modify the online access restriction policy, the request being associated with further access parameters, and based on the further access parameters, modifying the online access restriction policy.

40. The computer-implemented method of claim 28, wherein a history of all attempts to access Internet content is stored and accessible for processing and analysis.

41. The computer-implemented method of claim 28, wherein the user with administrative authority receives reports regarding the online access restriction policies, the reports including a total amount of time each access restriction policy is in effect and any web content that a user attempted to access during the time a given access restriction policy was in effect.

42. The computer-implemented method of claim 28, wherein the user with administrative authority specifics different restriction policies for different locations.

43. A computer-implemented system for restricting online access, the system comprising:
a user interface module to provide a user interface between at least one user and a DNS server;
a communication module to receive, from a user with administrative authority via the user interface, a request to set one or more online access restriction policies for a network, the request including access parameters; and
a policy generating module to establish, based on the access parameters, one or more time periods during which access to Internet content not specifically excepted is blocked.

44. The computer-implemented system of claim 43, wherein the Internet service includes a predefined a set of excepted Internet content that all end users access while the restriction policy is in effect.

45. The computer-implemented system of claim 43, further comprising a policy activation module to activate and deactivate the online access restriction policy.

46. The computer-implemented system of claim 43, further comprising a policy enforcing module to receive from a network user a request to access content, to determine that the online access restriction policy is activated and the content is inaccessible under the online access restriction policy, and based on the determination, to block the content.

47. The computer-implemented system of claim 45, further comprising an information module to provide, to the network user, information regarding the online access restriction policy.

48. The computer-implemented system of claim 43, further comprising a policy modification module to receive from the user, via the user interface, a further request to modify the online access restriction policy, the request including further access parameters, and to modify the online access restriction policy based on the further restriction parameter.

49. A non-transitory machine-readable medium comprising instructions, which when implemented by one or more processors, perform the following operations:
provide a user interface between at least one user and a DNS server;
receive from a user with administrative authority, via the user interface, a request to establish one or more online access restriction policies for a network, the request including access parameters; and
establish the online access restriction policy for the network based on the access parameters, the access restriction policy during one or more time periods blocking access to Internet content which is not specifically excepted.
